(19) United States
(12) Patent Application Publication
(10) Pub. No.: US 2016/0362238 A1
(43) Pub. Date: Dec. 15, 2016

(54) PACKAGE FOR THERMALLY PROCESSED MEAT-BASED PRODUCT, WITH AN EASY-OPENING ABILITY

(71) Applicant: NOVAPLOT ENTERPRISES LTD, Limassol (CY)

(72) Inventor: Emmanouil DOMAZAKIS, Rethymnon (GR)

(73) Assignee: NOVAPLOT ENTERPRISES LTD, Limassol (CY)

(21) Appl. No.: 14/953,189

(22) Filed: Nov. 27, 2015

(30) Foreign Application Priority Data
Jun. 9, 2015 (GR) 20150200068

(51) Int. Cl. B65D 75/58; B65D 85/00; B65D 65/38

(52) U.S. Cl. CPC B65D 75/58; A23L 1/31; B65D 65/38; B65D 85/70; A23V 2002/00

(57) ABSTRACT

The present invention is related to a package for a thermally processed meat-based product, which has the ability of easy opening. Preferably, the said package is intended for a thermally processed meat-based product, which is provided in individual portions.

The present invention is related to a package for a thermally processed meat-based product, which has an easy-opening ability. Preferably, the said package in intended for use in the packaging of a thermally processed meat-based product, that is provided in individual portions.

In the context of the present invention, the term “thermally processed meat-based product” of sausage type, refers to a finely- or/and coarsely comminuted meat mass, which has been subjected to a thermal treatment, following its encasing under vacuum into suitable casings. Furthermore, the terms “meat-based products” or “meat preparations” refer to any product of the group, comprising thermally processed meat-based products or meat preparations, which are based on a finely- or coarsely-comminuted meat mass.

The food packaging materials that are conventionally used for thermally processed meat-based products, are either natural (obtained from intestines of young ruminants and pigs), or artificial (made of cellulose, collagen-based, synthetic materials). Certain packaging materials are edible (e.g. collagen sausage casings), while others need to be peeled-off following thermal treatment (e.g. cellulose casings as in the case of frankfurter-type sausages). The synthetic casings used for the production of thermally processed meat-based products of Parizer type, for example, may be either single-layered or multi-layered and constitute the safer solution for assuring the microbiological safety of the product. They present limited permeability to oxygen (e.g. <15 cm³/m²/d at 23° C. and 53% RH) and allow longer shelf life. Such synthetic polymer-based casings, however, do not allow the removal of the casing from the end-product by hand, and an easy access to the product.

Moreover, the conventional casings used in the packaging of thermally processed meat-based products, are not intended for packaging individual portions and differ per product type and post-processing stage. For example, meat preparations like parizers are provided in items of 300 gr, encased into synthetic polymer-based casings, or they are provided sliced in containers of 100-200 gr of product (average slice weight of 20 gr). Thus, with the opening of the package, the whole product is exposed to quality deterioration factors.

An advantage of the present invention is that it provides an easy-opening ability of a package, to enable the consumer having an easy access to the product, anytime of the day, without the need of a utensil. Moreover, the controlled adhesion to the thermally processed meat mass is rendered possible, which aids casing removal. Another advantage of the present invention is that the package herein disclosed, is ideal for use in individually portioned meat-based products. Such potential, assures on one hand, the preservation of the organoleptic/textural features, as well as the microbiological safety of the product. This allows the possibility of consumption of certain portion/portions of the product, without exposing larger product quantities into quality deterioration factors.

The package, according to the present invention, comprises a multilayered packaging film, comprising synthetic polymers, which provide a limited permeability to oxygen (e.g. <40 cm³ /m²/d) and water vapour (e.g. <4 g/m²/d), the possibility of a single layer detachment, at a first stage, in a controlled manner, as well as the controlled adhesion to the thermally processed meat mass.

The said package comprises a heat-sealed field, which forms the shape of the container to be stuffed and is located on the longitudinal axis of said container. The package further comprises a non-sealed surface, which extends parallel to the heat-sealed field. The non-sealed surface has at least one tear notch, perpendicular to the heat-sealed field, that allows the opening of the package by a rotational motion. According to a preferred embodiment of the present invention, the herein disclosed package is intended for the packaging of an individually portioned meat-based product, of weight from 5 to 70 gr, in order to reduce the exposure of larger quantities of said product to factors that could deteriorate its quality (e.g. microbiological risks).

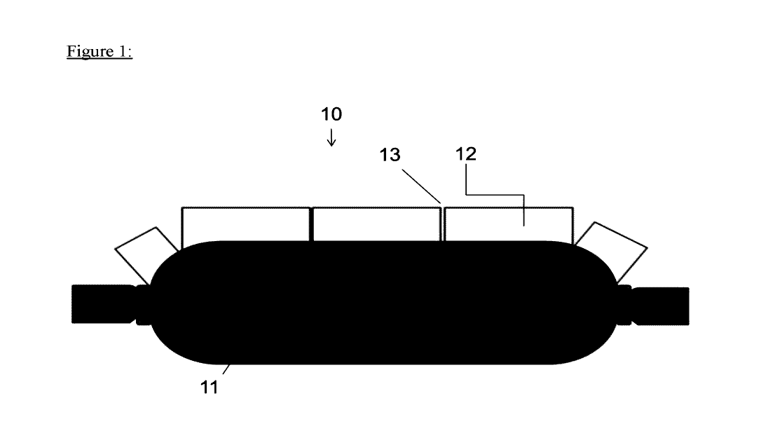

A preferred embodiment is illustrated in FIG. 1. FIG. 1 illustrates a package (10) with an easy-opening ability. Said package is formed into a cylindrical shape by means of a heat-sealing procedure. The heat-sealing procedure defines a heat-sealed field, located on the longitudinal axis of the container (11). A free non-sealed surface (12) extends parallel to the heat-sealed field and is characterized by the presence of tear notches (13) perpendicular to the heat-sealed field, which allow the removal of the package by rotational motion.

The package of the present invention, is made of a packaging material, comprising individual material layers (laminate), which allow: I) controlled permeability to oxygen (e.g. <40 cm³/m²/d) and water vapour (e.g. <4 g/m²/d) and in consequence protection of the enclosed thermally-processed meat mass, II) easy-opening ability (easy-peel) of the package, i.e. the easy single layer detachment, at an initial stage and in a controlled manner, in order to initiate the process of package removal, III) controlled adhesion to the thermally processed meat mass, in order to aid the package removal.

The above requirements I) to III) are met by the use of a multilayered packaging film, which is substantially comprised of polymers, such as Polyethylene (PE) and Polyamide (PA).

The multilayered packaging film takes the form of a sausage casing, by the process of heat sealing (e.g. at a temperature range between 162-168° C.). In specific, the multilayered packaging film (of thickness e.g. 80 μm) having the desired structure and width, is formed into a cylindrical shape and it takes its final form as a sausage casing, with the procedure of heat sealing. The latter defines a heat-sealed field onto the longitudinal axis of the container.

According to a preferred embodiment of the present invention, the layer of the multilayered packaging film which comes into direct contact with the meat mass, comprises Polyethylene (PE). More preferably, the outer layer of the multilayered packaging film also comprises Polyethylene (PE). Even more preferably, a middle layer of the multilayered packaging film is based on Polyamide (PA).

In order to facilitate the easy-opening of the package by hand, the package has a free non-sealed surface (12), which is an integral part of the package. This free non-sealed surface is formed during the process of heat -sealing and is parallel with the heat-sealed field (11) and in consequence also parallel to the longitudinal axis of the container. Moreover, the free non-sealed surface of the package has at least one tear notch, which is perpendicular to the longitudinal axis of the heat sealed field (13) and facilitates the easy opening of the package by rotational motion. Preferably, the non-sealed surface has a number of tear notches, which is analogous to its length. It is preferred that the multilayered packaging film bears tear notches at the side, which is intended to form part of the non-sealed surface, after the heat sealing procedure. In this way, the non-sealed surface of the ready sausage casing to be stuffed with the meat mass, bears a number of tear notches perpendicular to the longitudinal axis of the heat-sealed field. The tear notches define relative parallelograms, the dimensions of which should allow the easy opening of the package by hand.

Moreover, the present invention is related to the use of the herein disclosed package, for packaging individual portions of a thermally processed meat product, of weight from 5 to 70 gr, which allow the consumer the possibility of consuming certain portion/portions of a thermally processed meat-based product, without exposing larger quantities thereof to quality deterioration factors.

1. A package for a thermally processed meat-based product with an easy-opening ability, comprising:
I. A multilayered packaging film, comprising synthetic polymers,
II. A heat-sealed field, which forms the shape of the container to be stuffed, and is located on the longitudinal axis of the container,
III. A non-sealed surface, which extends parallel to the heat-sealed field, where the non-sealed surface has at least one tear notch perpendicular to the heat- sealed field and said at least one tear notch enables the opening of the package by rotational motion.

2. The package of claim 1, where the multilayered packaging film comprises polyethylene and polyamide.

3. The package of claim 1, where the layer of the multilayered packaging film that comes in direct contact with the product comprises polyethylene.

4. The package of claim 1, where the non-sealed surface has a number of tear notches, analogous to the length of the non-sealed surface.

5. A packaged meat-based product comprising 5 to 70 grams of a meat-based product contained within a package of claim 1.
